(19) United States
(12) Patent Application Publication
(10) Pub. No.: US 2020/0008414 A1
(43) Pub. Date: Jan. 9, 2020

(54) Waist Wearable Fishing Kit

(71) Applicant: Jeroen Brouwer, Emerald Isle, NC (US)

(72) Inventor: Jeroen Brouwer, Emerald Isle, NC (US)

(21) Appl. No.: 16/026,769

(22) Filed: Jul. 3, 2018

(51) Int. Cl. A01K 97/08; A01K 87/02; A01K 97/06; A45F 3/00; A45F 3/14

(52) U.S. Cl. CPC A01K 97/08; A01K 87/025; A45F 2003/144; A45F 3/005; A45F 3/14; A01K 97/06

(57) ABSTRACT

A waist wearable fishing kit enabling impromptu fishing includes a strap and a fishing rod. A first and a second coupler, which are complementary, are coupled to a first and a second end of the strap, respectively. The strap is configured to loopedly position around a waist of a user, positioning the second coupler to couple to the first coupler. A pouch, which is water-impermeable, is coupled to the strap. An aperture that is positioned in a top of the pouch is configured to allow access to the pouch. A closure that is coupled to the pouch proximate to the aperture is positioned to selectively sealably close the aperture. A reel fitted with a line is coupled to the fishing rod, which comprises a plurality of sections that are selectively interconnectable so that the fishing rod is collapsible to stow in the pouch, positioning the user for impromptu fishing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to fishing kits and more particularly pertains to a new fishing kit enabling impromptu fishing.

### BRIEF SUMMARY OF THE INVENTION

An embodiment of the disclosure meets the needs presented above by generally comprising a strap and a fishing rod. A first and a second coupler, which are complementary, are coupled to a first and a second end of the strap, respectively. The strap is configured to loopedly position around a waist of a user, positioning the second coupler to couple to the first coupler. A pouch, which is water-impermeable, is coupled to the strap. An aperture that is positioned in a top of the pouch is configured to allow access to the pouch. A closure that is coupled to the pouch proximate to the aperture is positioned to selectively sealably close the aperture. A reel fitted with a line is coupled to the fishing rod, which comprises a plurality of sections that are selectively interconnectable so that the fishing rod is collapsible to stow in the pouch, positioning the user for impromptu fishing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a waist wearable fishing kit according to an embodiment of the disclosure.

FIG. 2 is a front view of an embodiment of the disclosure.

FIG. 3 is a rear view of an embodiment of the disclosure.

FIG. 4 is a top view of an embodiment of the disclosure.

FIG. 5 is an in-use view of an embodiment of the disclosure.

### DETAILED DESCRIPTION OF THE INVENTION

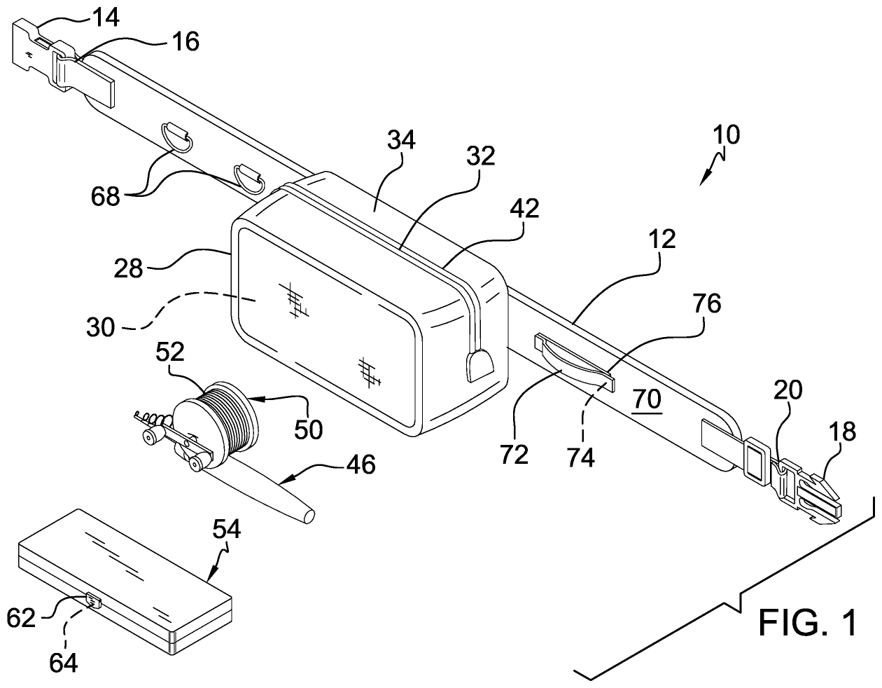

With reference now to the drawings, and in particular to FIGS. 1 through 5 thereof, a new fishing kit embodying the principles and concepts of an embodiment of the disclosure and generally designated by the reference numeral 10 will be described.

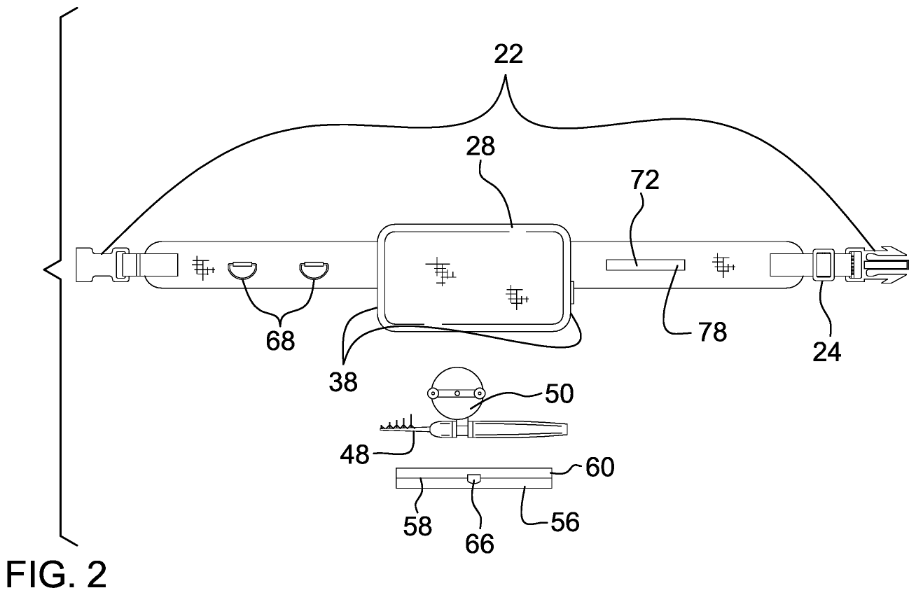

As best illustrated in FIGS. 1 through 5, the waist wearable fishing kit 10 generally comprises a strap 12. A first coupler 14 is coupled to a first end 16 of the strap 12. A second coupler 18 is coupled to a second end 20 of the strap 12. The second coupler 18 is complementary to the first coupler 14. The strap 12 is configured to loopedly position around a waist of a user, positioning the second coupler 18 to couple to the first coupler 14 to removably couple the strap 12 to the user. The first coupler 14 and the second coupler 18 comprise a side-release buckle 22, as shown in FIG. 2. The second coupler 18 is slidably coupled to the strap 12 so that the strap 12 is length adjustable to fit the strap 12 to the waist of the user.

A strap buckle 24 is positioned on the strap 12 proximate to the second coupler 18, as shown in FIG. 2. The strap buckle 24 is positioned to selectively insert the second end 20 of the strap 12 to selectively fixedly position the second coupler 18 relative to the first coupler 14 to fit the strap 12 to the waist of the user.

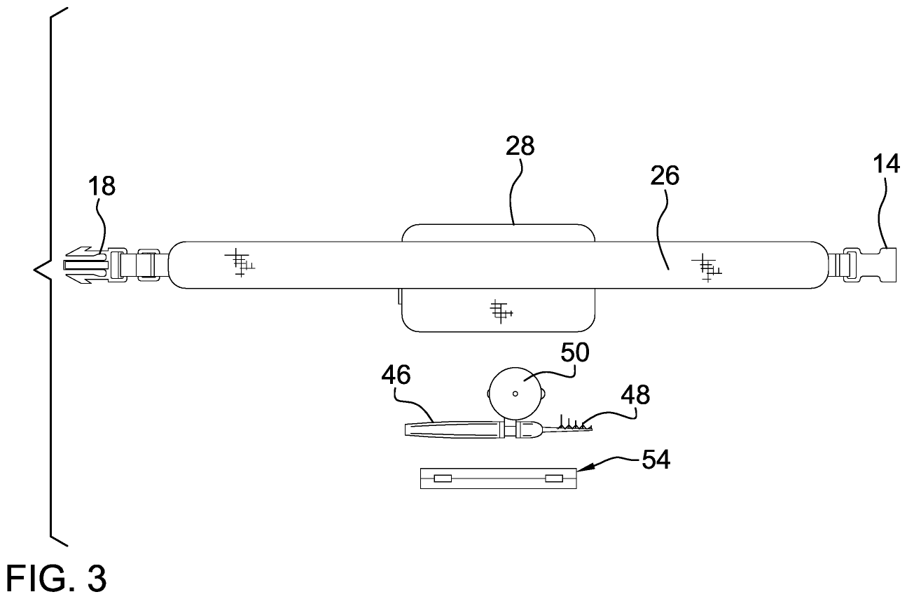

A pad 26 is coupled to the strap 12, as shown in FIG. 3. The pad 26 extends from proximate to the first end 16 to proximate to the second end 20 of the strap 12. The pad 26 is configured to cushion the waist of the user from the strap 12.

A pouch 28 is coupled to the strap 12, as shown in FIG. 1. The pouch 28 defines an interior space 30. The pouch 28 is water-impermeable, comprising expanded polytetrafluoroethylene, coated nylon, or the like. The pouch 28 is substantially rectangularly box shaped. The pouch 28 is positioned substantially equally distant from the first end 16 and the second end 20 of the strap 12.

An aperture 32 is positioned in a top 34 of the pouch 28. The aperture 32 is configured to allow access to the interior space 30. The aperture 32 comprises a slit 36 that extends between opposing ends 38 of the pouch 28. The slit 36 also extends from the top 34 along each of the opposing ends 38 toward a bottom 40 of the pouch 28.

A closure 42 is coupled to the pouch 28 proximate to the aperture 32. The closure 42 is positioned to selectively and sealably close the aperture 32. The closure 42 comprises a zipper 44 that is positioned to sealably close the slit 36.

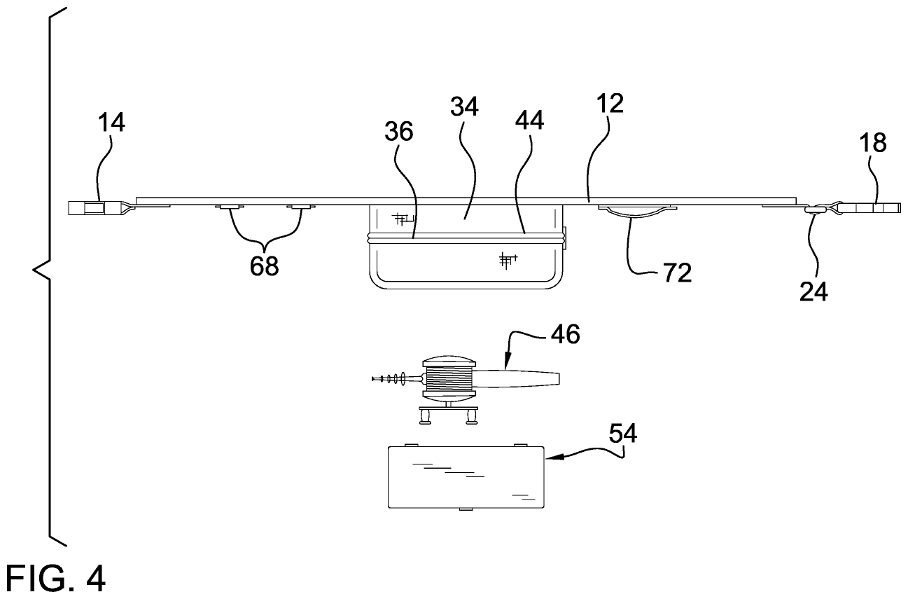

The kit 10 also comprises a fishing rod 46 and a reel 50. The fishing rod 46 comprises a plurality of sections 48. The sections 48 are selectively interconnectable so that the fishing rod 46 is collapsible to stow in the pouch 28. The plurality of sections 48 is nested so that the fishing rod 46 is selectively extensible, as shown in FIG. 4. The reel 50 is coupled to the fishing rod 46. The reel 50 is positioned to selectively extend a line 52 from the reel 50, positioning the user to fish.

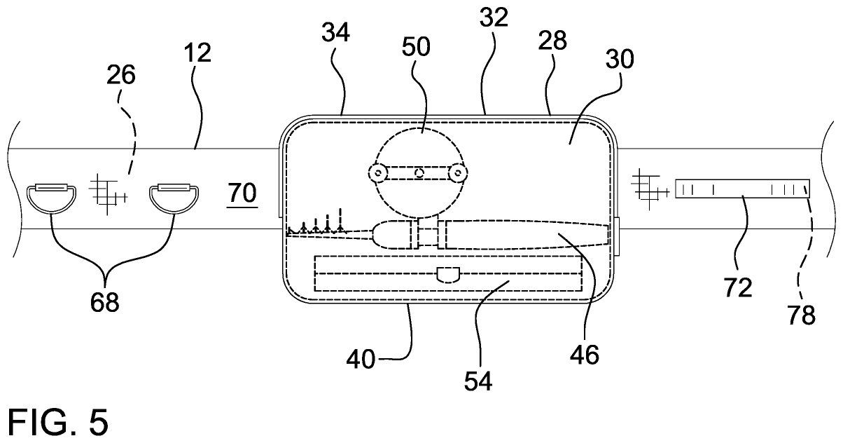

The kit 10 also comprises container 54 that is sized to stow in the pouch 28 along with the fishing rod 46 and the reel 50. The container 54 is configured to stow gear for fishing, such as lures and bait. With the fishing rod 46, the reel 50, and the gear stowed in the pouch 28, as shown in FIG. 5, the user is positioned to couple the strap 12 around his or her waist. This allows the user to easily carry the kit 10 during water activities, such as surfing, kayaking, canoeing, and paddle boarding. Should the user be presented with an opportunity to fish, the fishing rod 46, the reel 50, and the gear are readily available for use.

The container 54 comprises a box 56, as shown in FIG. 1. The box 56 has an upper end 58 that is open. A lid 60 is hingedly coupled to the box 56 proximate to the upper end 58. The lid 60 is positioned to selectively close the upper end 58 of the box 56.

A first connector 62 is coupled to the box 56. A second connector 64 is coupled to the lid 60. The second connector 64 is complementary to the first connector 62. The second connector 64 is positioned to selectively couple to the first connector 62 to removably couple the lid 60 to the box 56 to close the upper end 58 of the box 56. The second connector 64 and the first connector 62 comprise a snap closure 66, as shown in FIG. 2.

Each of a plurality of rings 68 is hingedly coupled to an outer face 70 of the strap 12. Each ring 68 is configured to retain a respective article of the user, such as a fish stringer, a rod holder, and a cutting pliers. The rings 68 are substantially D-shaped. The plurality of rings 68 comprises two rings 68 that are positioned between the pouch 28 and the first end 16 of the strap 12.

A strip 72 is coupled to and extends from the outer face 70 of the strap 12. A first fastener 74 is coupled to the strip 72 distal from the strap 12. A second fastener 76 is coupled to the outer face 70 to the strap 12. The second fastener 76 is complementary to the first fastener 74. The strip 72 is configured to loopedly position around an item of the user, such as a rod holder and a paddle, positioning the second fastener 76 to couple to the first fastener 74 to removably couple the item to the strap 12. The second fastener 76 and the first fastener 74 comprise a hook and loop fastener 78, as shown in FIG. 5. The second fastener 76 is positioned between the pouch 28 and the second end 20 of the strap 12.

In use, the fishing rod 46, the reel 50, and the container 54 containing the gear are stowed in the interior space 30 of the pouch 28 and the slit 36 is sealably closed with the zipper 44. The side-release buckle 22 then is used to couple the strap 12 together around the waist of the user. The user then undertakes his or her desired water-related activity. In the event the user elects to fish, the fishing rod 46, the reel 50, and the gear are readily available for use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A waist wearable fishing kit comprising:
a strap;
a first coupler coupled to a first end of the strap;
a second coupler coupled to a second end of the strap, the second coupler being complementary to the first coupler wherein the strap is configured for loopedly positioning around a waist of a user positioning the second coupler for coupling to the first coupler for removably coupling the strap to the user;
a pouch coupled to the strap, the pouch defining an interior space, the pouch being water-impermeable;
an aperture positioned in a top of the pouch wherein the aperture is configured for accessing the interior space;
a closure coupled to the pouch proximate to the aperture wherein the closure is positioned for selectively sealably closing the aperture;
a fishing rod, the fishing rod comprising a plurality of sections, the sections being selectively interconnectable such that the fishing rod is collapsible for stowing in the pouch; and
a reel coupled to the fishing rod wherein the reel is positioned for selectively extending a line from the reel positioning the user for fishing.

2. The kit of claim 1, further including the first coupler and the second coupler comprising a side-release buckle.

3. The kit of claim 1, further including the second coupler being slidably coupled to the strap such that the strap is length adjustable for fitting the strap to the waist of the user.

4. The kit of claim 3, further including a strap buckle positioned on the strap proximate to the second coupler such that the strap buckle is positioned for selectively inserting the second end of the strap wherein the strap buckle is positioned for selectively fixedly positioning the second coupler relative to the first coupler for fitting the strap to the waist of the user.

5. The kit of claim 1, further including a pad coupled to the strap, the pad extending from proximate to the first end to proximate to the second end of the strap wherein the pad is configured for cushioning the waist of the user from the strap.

6. The kit of claim 1, further including the pouch being substantially rectangularly box shaped.

7. The kit of claim 1, further including the pouch being positioned substantially equally distant from the first end and the second end of the strap.

8. The kit of claim 6, further comprising:
the aperture comprising a slit extending between opposing ends of the pouch. including; and
the closure comprising a zipper wherein the zipper is positioned for sealably closing the slit.

9. The kit of claim 8, further including the slit extending from the top along each of the opposing ends toward a bottom of the pouch;

10. The kit of claim 1, further including the plurality of sections being nested such that the fishing rod is selectively extensible.

11. The kit of claim 1, further including a container sized for stowing in the pouch with the fishing rod and the reel wherein the container is configured for stowing gear for fishing.

12. The kit of claim 11, further including the container comprising:
a box, the box having an upper end, the upper end being open;
a lid hingedly coupled to the box proximate to the upper end wherein the lid is positioned for selectively closing the upper end of the box;
a first connector coupled to the box; and
a second connector coupled to the lid, the second connector being complementary to the first connector wherein the second connector is positioned for selectively coupling to the first connector for removably coupling the lid to the box for closing the upper end of the box.

13. The kit of claim 12, further including the second connector and the first connector comprising a snap closure.

14. The kit of claim 1, further including a plurality of rings, each ring being hingedly coupled to an outer face of the strap wherein each ring is configured for retaining a respective article of the user.

15. The kit of claim 14, further including the rings being substantially D-shaped.

16. The kit of claim 14, further including the plurality of rings comprising two rings positioned between the pouch and the first end of the strap.

17. The kit of claim 1, further comprising:
a strip coupled to and extending from an outer face of the strap;
a first fastener coupled to the strip distal from the strap; and
a second fastener coupled to the outer face to the strap, the second fastener being complementary to the first fastener wherein the strip is configured for loopedly positioning around an item of the user positioning the second fastener for coupling to the first fastener for removably coupling the item to the strap.

18. The kit of claim 1, further including the second fastener and the first fastener comprising a hook and loop fastener.

19. The kit of claim 1, further including the second fastener being positioned between the pouch and the second end of the strap.

20. A waist wearable fishing kit comprising:
a strap;
a first coupler coupled to a first end of the strap;
a second coupler coupled to a second end of the strap, the second coupler being complementary to the first coupler wherein the strap is configured for loopedly positioning around a waist of a user positioning the second coupler for coupling to the first coupler for removably coupling the strap to the user, the first coupler and the second coupler comprising a side-release buckle, the second coupler being slidably coupled to the strap such that the strap is length adjustable for fitting the strap to the waist of the user;
a strap buckle positioned on the strap proximate to the second coupler such that the strap buckle is positioned for selectively inserting the second end of the strap wherein the strap buckle is positioned for selectively fixedly positioning the second coupler relative to the first coupler for fitting the strap to the waist of the user;
a pad coupled to the strap, the pad extending from proximate to the first end to proximate to the second end of the strap wherein the pad is configured for cushioning the waist of the user from the strap;
a pouch coupled to the strap, the pouch defining an interior space, the pouch being water-impermeable, the pouch being substantially rectangularly box shaped, the pouch being positioned substantially equally distant from the first end and the second end of the strap;
an aperture positioned in a top of the pouch wherein the aperture is configured for accessing the interior space, the aperture comprising a slit extending between opposing ends of the pouch, the slit extending from the top along each of the opposing ends toward a bottom of the pouch;
a closure coupled to the pouch proximate to the aperture wherein the closure is positioned for selectively sealably closing the aperture, the closure comprising a zipper wherein the zipper is positioned for sealably closing the slit;
a fishing rod, the fishing rod comprising a plurality of sections, the sections being selectively interconnectable such that the fishing rod is collapsible for stowing in the pouch, the plurality of sections being nested such that the fishing rod is selectively extensible;
a reel coupled to the fishing rod wherein the reel is positioned for selectively extending a line from the reel positioning the user for fishing;
a container sized for stowing in the pouch with the fishing rod and the reel wherein the container is configured for stowing gear for fishing, the container comprising:
a box, the box having an upper end, the upper end being open,
a lid hingedly coupled to the box proximate to the upper end wherein the lid is positioned for selectively closing the upper end of the box,
a first connector coupled to the box, and
a second connector coupled to the lid, the second connector being complementary to the first connector wherein the second connector is positioned for selectively coupling to the first connector for removably coupling the lid to the box for closing the upper end of the box, the second connector and the first connector comprising a snap closure;
a plurality of rings, each ring being hingedly coupled to an outer face of the strap wherein each ring is configured for retaining a respective article of the user, the rings being substantially D-shaped, the plurality of rings comprising two rings positioned between the pouch and the first end of the strap;
a strip coupled to and extending from the outer face of the strap;
a first fastener coupled to the strip distal from the strap; and
a second fastener coupled to the outer face to the strap, the second fastener being complementary to the first fastener wherein the strip is configured for loopedly positioning around an item of the user positioning the second fastener for coupling to the first fastener for removably coupling the item to the strap, the second fastener and the first fastener comprising a hook and loop fastener, the second fastener being positioned between the pouch and the second end of the strap.
